(19) United States
(12) Patent Application Publication
(10) Pub. No.: US 2025/0153901 A1
(43) Pub. Date: May 15, 2025

(54) MULTI-COMPARTMENT BABY FORMULA POUCH

(71) Applicants: Victor Burtea, Irvine, CA (US); Alexander Burtea, Ladera Ranch, CA (US); Daniel Burtea, Whittier, CA (US)

(72) Inventors: Victor Burtea, Irvine, CA (US); Alexander Burtea, Ladera Ranch, CA (US); Daniel Burtea, Whittier, CA (US)

(21) Appl. No.: 18/506,661

(22) Filed: Nov. 10, 2023

(51) Int. Cl. B65D 25/08; A61J 9/00; B65D 75/00; B65D 75/58

(52) U.S. Cl. CPC B65D 25/082; A61J 9/005; B65D 75/008; B65D 75/5883; B65D 2401/00

(57) ABSTRACT

According to an aspect of the present invention, there is provided a multi-compartment baby formula pouch, comprising: a foil pouch; a chamber containing a formula in powder form; a chamber containing a liquid; and a frangible seal, wherein the frangible seal is broken when pressure is applied allowing the powder and the liquid to mix.

### BACKGROUND

Pouches configured for holding liquids are well-known in the prior art patent literature.

For example, U.S. Pat. No. 7,810,677 discloses a flexible pouch defining a variable volume storage chamber and one-way valve assembly for aseptically storing a substance, dispensing multiple portions of the stored substance therefrom in cooperation with a pump, and maintaining substance remaining in the pouch in an aseptic condition sealed with respect to ambient atmosphere. The one-way valve includes a valve seat and elastic valve cover portion overlying the valve seat forming an interference fit therewith defining a normally-closed seam therebetween. The valve portion is movable radially between (i) a normally closed position with the valve portion engaging the valve seat, and (ii) an open position with at least a segment of the valve portion spaced radially away from the valve seat to allow substance from the storage chamber through the valve opening. The one-way valve maintains substance remaining in the variable-volume storage chamber in an aseptic condition sealed with respect to the ambient atmosphere.

Containers specialized for infant formula have also been described. For example, US20140299598 describes a container comprising: a body having a bottom and a side wall defining a reservoir; a collar attached to a top end of the body; a removable seal at the top end of the body to seal the reservoir; and, a lid hingedly engaged with the collar, the lid having an underside and configured to provide a docking station on the underside for holding a measuring device.

Nevertheless, convenient containers for holding powdered infant formula have continued to be elusive.

### SUMMARY OF INVENTION

Therefore, the present invention provides a convenient multi-compartment baby formula pouch with a compartment for powdered formula and compartment for liquid to mix with the formula.

According to an aspect of the present invention, there is provided a multi-compartment baby formula pouch, comprising: a foil pouch; a chamber containing a formula in powder form; a chamber containing a liquid; and a frangible seal, wherein the frangible seal is broken when pressure is applied allowing the powder and the liquid to mix.

### BRIEF DESCRIPTION OF THE DRAWINGS

FIG. 1 illustrates a multi-compartment baby formula pouch according to an embodiment of the present invention.

FIG. 2 illustrates a holder and a silicone nipple separately positioned side by side.

FIG. 3 illustrates the silicone nipple of FIG. 2 attached to the holder of FIG. 2.

### DETAILED DESCRIPTION

Typically, infant formula is a granulated or powder product packaged dry in a container. It is often difficult to use the container and dispense the powder formula from the container. Once the container is opened, the powdered formula is often packed into parts of the interior of the lid or top of the container, which results in waste. While some of the powder may fall back into the interior of the container, much of it is wasted and contaminated as it spills onto the surrounding workspace. Additionally, prior art containers may allowing the contents to become contaminated.

The present invention provides a superior method of storing and dispensing infant formula. It has a unique silicone nipple and a unique plastic holder. It has a type of aluminum foil for the pouch section with a “frangible seal” that will burst open once pressure is applied to it. One compartment will have distilled water, and the other section will have the baby formula.

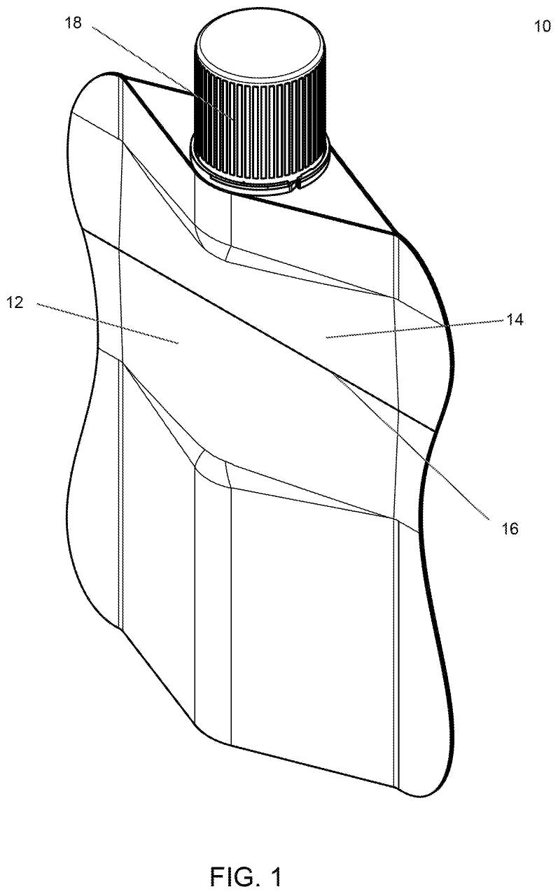

FIG. 1 illustrates a multi-compartment baby formula pouch according to an embodiment of the present invention.

Pouch 10 is topped by cap 18 which covers a silicone nipple not visible in FIG. 1. Pouch 10 has two compartments, one for liquid storage 12 and one for powder storage 14, which are separated by frangible seal 16. Pouch 10 can be of aluminum foil, for example.

Liquid storage 12 typically will contain distilled water, but in some embodiments may contain bottled or tap water or another liquid.

Powder storage 14 contains powdered formula. Powdered formula is designed to be mixed with a specified amount of water before being consumed by an infant. It is typically difficult to use the exact amount of water and formula listed on the formula container instructions, and the present invention addresses that difficulty very well.

Frangible seal 16 separates the liquid and the powder. Frangible seal is configured to open when pressure is applied.

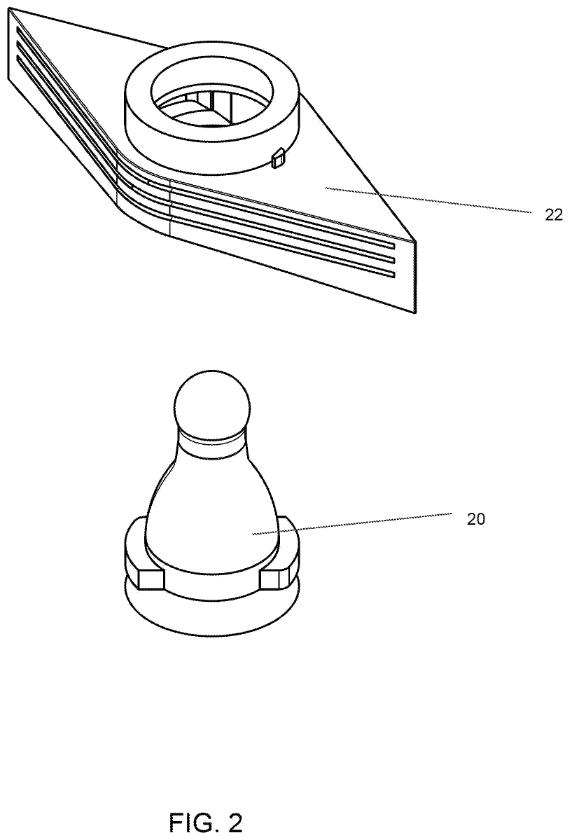

FIG. 2 illustrates a holder and silicone nipple separately positioned side by side.

Holder 22 can be plastic or a similar material, for example. Holder 22 is configured to receive silicone nipple 20 and cap 18 (which is not shown in the view of FIG. 2).

Silicone nipple 20 can be food-grade silicone, for example, which is a safe, durable and hygienic material for baby bottle nipples. Natural rubber nipples or synthetic latex nipples may be used in other embodiment.

In an alternate embodiment, a silicone nipple and nipple holder are silicone and are merged into one piece.

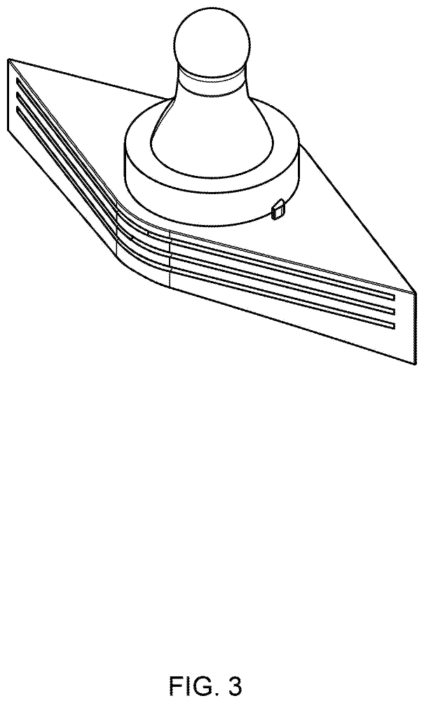

FIG. 3 illustrates the silicone nipple of FIG. 2 attached to the holder of FIG. 2.

Silicone nipple 20 can connect to nipple holder 22 by a notch or other connecting member. Silicone nipple 20 can screw or snap on to nipple holder 22 or be connected in another fashion.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Similar numerals designate similar elements among the several figures. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A multi-compartment baby formula pouch, comprising:
a foil pouch;
a chamber containing a formula in powder form;
a chamber containing a liquid; and
a frangible seal, wherein the frangible seal is broken when pressure is applied allowing the powder and the liquid to mix.

2. The multi-compartment baby formula pouch of claim 1, further comprising a nipple holder.

3. The multi-compartment baby formula pouch of claim 1, further comprising a nipple.

4. The multi-compartment baby formula pouch of claim 1, wherein the liquid is distilled water.

5. The multi-compartment baby formula pouch of claim 1, further comprising a tamper evident band is located on a portion of the pouch.

6. The multi-compartment baby formula pouch of claim 2, wherein the nipple holder is made of a plastic material.

7. The multi-compartment baby formula pouch of claim 3, further comprising a nipple is made of a material comprising silicone.

8. The multi-compartment baby formula pouch of claim 1, wherein the foil is made of a material comprising aluminum.

9. The multi-compartment baby formula pouch of claim 1, wherein the baby formula pouch is in an hourglass shape.

10. The multi-compartment baby formula pouch of claim 2, further comprising a cap attached to the nipple holder.

11. The multi-compartment baby formula pouch of claim 1, further comprising a silicone nipple and nipple holder merged into one piece.
